(19) United States
(12) Patent Application Publication
(10) Pub. No.: US 2017/0090032 A1
(43) Pub. Date: Mar. 30, 2017

(54) VEHICLE LIDAR SYSTEM

(71) Applicant: Robert Bosch GmbH, Stuttgart (DE)

(72) Inventor: Heiko Ridderbusch, Schwieberdingen (DE)

(21) Appl. No.: 15/310,938

(22) PCT Filed: May 26, 2015
(86) PCT No.: PCT/EP2015/061547

§ 371 Date: Nov. 14, 2016

(30) Foreign Application Priority Data
Jun. 11, 2014 (DE) 102014211071.8

(51) Int. Cl. G01S 17/89; G01S 7/481; G01S 7/486; G01S 17/93

(52) U.S. Cl. CPC G01S 17/89; G01S 17/936; G01S 7/4817; G01S 7/4861; G01S 7/4816; G01S 7/4814

(57) ABSTRACT

A vehicle LIDAR system, including: a pulse laser for emitting laser pulses; at least one movably situated mirror for deflecting the laser pulses in the direction of objects to be detected; a receiver for detecting the laser pulses reflected by the objects, the receiver including a CMOS compatible image sensor for detecting the reflected laser pulses and for recording an image of an area illuminatable with the aid of the deflected laser pulses.

### FIELD

The present invention relates to a vehicle LIDAR system and to a use of the vehicle LIDAR system.

### BACKGROUND INFORMATION

A laser and optics system for use in vehicle-based LIDAR systems is described in German Patent Application No. DE 10 2007 004 609 A1. The system includes a semiconductor laser array and a suitable lens or other optics system. The system is operated in a way that it is replaces LIDAR laser systems which use mechanically rotated or deflected reflective optics.

German Patent Application No. DE 10 2011 115 717 A1 describes handheld binoculars including a spectrometer. The spectrometer may include silicon sensors, for example.

German Patent Application No. DE 10 207 610 A1 describes a method and a device for detecting and processing electrical and visual signals.

Present camera systems for automotive applications generally operate with inexpensive CMOS silicon detectors in the visible wavelength range or near infrared or with more costly indium gallium arsenide (InGaAs) detectors in the wavelength range greater than 900 nm to 1700 nm. LIDAR systems generally operate at 905 nm with silicon detectors, or at 1.5 μm also with more costly InGaAs detectors or germanium detectors. Both sensors are generally stand-alone systems.

If necessary, the measuring data are linked to each other by sensor fusion.

### SUMMARY

It is an object of the present invention to provide a vehicle LIDAR system.

It is another object of the present invention to provide a use of the vehicle LIDAR system.

Advantageous embodiments of the present invention are described herein.

According to one aspect of the present invention, a vehicle LIDAR system is provided, including:
a pulse laser for emitting laser pulses;
at least one movably situated mirror for deflecting the laser pulses in the direction of objects to be detected;
a receiver for detecting the laser pulses reflected by the object;
the receiver including a CMOS-compatible image sensor for detecting the reflected laser pulses and for recording an image of an area illuminatable with the aid of the deflected laser pulses.

According to a further aspect, the vehicle LIDAR system is used for detecting objects in the surroundings of a vehicle. This means that objects in the surroundings of a vehicle are detected with the aid of the vehicle LIDAR system. In particular, a time of flight measurement of the laser pulses is carried out with the aid of the vehicle LIDAR system, so that advantageously a distance measurement with respect to objects to be detected may be carried out.

According to another aspect, a vehicle including the vehicle LIDAR system is provided.

The present invention thus in particular includes providing a receiver (which may also be referred to as a detector) for detecting the laser pulses reflected by the objects, the receiver including a CMOS-compatible image sensor (which may also be spelled without a hyphenation, i.e., “CMOS compatible image sensor”), which is able to both detect the reflected laser pulses and record an image of an area illuminatable with the aid of the deflected laser pulses. The CMOS-compatible image sensor according to the present invention thus has a dual function: detecting the reflected laser pulses and recording an image. Contrary to conventional systems, thus only a single sensor is necessary to provide both a LIDAR function (in particular for a distance measurement) and an image detection function. Contrary to this, two sensors are conventionally necessary in order for the above-mentioned functions to be effectuated or provided. Compared to the convention systems, the vehicle LIDAR system according to the present invention is thus smaller and more compact and may thus be installed in a smaller installation space.

According to one specific embodiment, the CMOS-compatible image sensor is a CMOS image sensor.

In a CMOS image sensor, the CMOS process may be used without alteration and/or modification. The CMOS basic process is to be used in a CMOS compatible image sensor, but changes to the process (modification, new process step, and the like) are possible. This means that the CMOS image sensor is produced in the CMOS process. The CMOS compatible image sensor was at least partially produced in the CMOS process, i.e., based on the CMOS production process, changes and/or innovations in the production of the CMOS compatible image sensor having been carried out in comparison with to the CMOS production process.

According to one specific embodiment, it is provided that the CMOS compatible image sensor includes multiple pixels, and an evaluation electronics being provided, which is designed to read out signals of the pixels of the CMOS compatible image sensor and ascertain a distance from a detected object based on the read-out signals. This in particular yields the technical advantage that a corresponding time of flight measurement of the laser pulses may be carried out for each pixel. This means that each pixel signal per se may be used to ascertain the distance from a detected object. In particular, it is provided that a group of pixels is read out, the read-out signals of the group of these pixels being used to ascertain a distance from a detected object. In this way, a so-called time of flight (TOF) measurement is advantageously carried out.

In another specific embodiment, it is provided that an optical element for mapping the illuminatable area onto the CMOS compatible image sensor is provided. This in particular yields the technical advantage that the illuminatable area may be optimally mapped onto the CMOS compatible image sensor so that the CMOS compatible image sensor is able to detect the entire illuminatable area, and thus is also able to detect objects situated in this illuminatable area. For example, the optical element is a lens or a mirror, such as a parabolic mirror. Preferably multiple optical elements are provided, which in particular are designed to be the same or different.

According to another specific embodiment, it is provided that the optical element has a transmission of at least 95%, for example >99%, for a wavelength range which corresponds to the laser wavelength plus minus ≦20 nm, preferably plus minus ≦10 nm, the transmission for wavelengths outside the wavelength range being smaller than 50%, preferably smaller than 20%. This in particular yields the technical advantage that a signal-to-noise ratio may be increased.

In another specific embodiment, it is provided that the CMOS compatible image sensor is designed to detect electromagnetic radiation having a wavelength of at least 900 nm, preferably of at least 1000 nm. This in particular yields the technical advantage that the CMOS compatible image sensor is also able to detect laser pulses which have a wavelength of at least 900 nm, preferably of at least 1000 nm. In this wavelength range of greater than 900 nm, preferably of greater than 1000 nm, the sensitivity with respect to damage to the eye due to this electromagnetic radiation is usually reduced, so that the use of the vehicle LIDAR system generally does not pose a risk to road users in the surroundings of the vehicle.

In another specific embodiment, it is provided that the CMOS compatible image sensor includes doped and/or surface-modified silicon as sensor material. This in particular yields the technical advantage that such a silicon is more sensitive to wavelengths greater than 900 nm, in particular greater than 1000 nm, compared to undoped or not surface-modified silicon. Such silicon is known, for example, as black silicon or as pink silicon. Sulfur may be provided as the dopant, for example.

In the case of a surface modification, a reflectivity is drastically reduced by a refractive index step from air to silicon, so that more incoming photons may penetrate into the image sensor and then be appropriately detected. The surface modification is carried out, for example, with the aid of structuring using short laser pulses. For example, these laser pulses have a pulse duration of ≦10 ns, for example of ≦1 ns. For example, a surface modification may be carried out with the aid of a coating. This means that the silicon is coated.

Doping the silicon in particular yields the technical effect that an absorption probability for photons is thus increased, so that a sensitivity of the detector is also increased at longer wavelengths.

According to another specific embodiment, it is provided that the pulse laser is a solid-state laser having a brightness of at least 100 kW/(mm² sr), which is designed to emit laser pulses having a wavelength of at least 900 nm, preferably of at least 1000 nm, and a maximum power per laser pulse of at least 50 W.

According to one specific embodiment, it is provided that the solid-state laser has a brightness of at least 1 MW/(mm² sr). The brightness of the solid-state laser preferably ranges between 100 kW/(mm² sr) and 1 MW/(mm² sr). In general, a higher brightness advantageously means a higher detection range of the vehicle LIDAR system. This means that also objects at distances from the solid-state laser of up to 200 m and more may advantageously be detected. The brightness may in particular be referred to as a beam quality. In optics and in laser technology, the brightness usually describes the bundling of a beam of electromagnetic radiation, here, of the laser beam.

According to one specific embodiment, it is provided that a maximum power per laser pulse is between 50 W and 100 W. Here too, a higher maximum power means a higher range. A maximum power per laser pulse means that it is also possible to emit laser pulses having a lower power. The maximum possible power per laser pulse accordingly is 50 W, 100 W, or a value between 50 W and 100 W.

According to one further specific embodiment, it is provided that the laser pulses have a duration of ≦100 ns, preferably of ≦50 ns, in particular of ≦10 ns, for example of ≦1 ns, in particular between 2 ns and 20 ns, preferably between 2 ns and 4 ns, for example 2.2 ns. In general, shorter pulse durations effectuate an improved accuracy or resolution with respect to a distance measurement.

According to one specific embodiment, it is provided that the pulse laser is electrically and/or optically pumpable or excitable. This means that the solid-state laser is or may be electrically and/or optically pumped or excited.

In another specific embodiment, it is provided that the solid-state laser is designed as a vertical cavity surface-emitting laser. The corresponding abbreviation is VCSEL. By providing such a vertical emitter, the above-described beam quality or brightness may advantageously be effectuated particularly easily compared to conventional edge emitters. This applies in particular also to ranges of the vehicle LIDAR system of >50 m, in particular up to 200 m, with a resolution of 1×1 m², for example, at 200 m. It is further advantageous that such a vertical emitter is more robust compared to conventional edge emitters. For example, it is not possible to destroy a VCSEL by an overcurrent, and thus an excessively high pulse power, at an outcoupling facet. Rather, a VCSEL at the most exhibits a thermal rollover. Such a thermal rollover does not result in destruction and is advantageously reversible. Furthermore, a VCSEL is producible and testable on a wafer level scale, so that manufacturing costs are scalable, in particular scalable similarly to high performance LEDs. During a thermal rollover, the laser material becomes hotter, whereby the efficiency decreases, as a result of which the material becomes even hotter. The laser extinguishes starting at a certain decrease in the efficiency. The LED and vertical emitters radiate the power upwardly. During manufacture, the radiation properties may still be tested if the entire wafer has not yet been separated. In contrast, an edge emitter radiates to the side, and testing is thus not possible. The wafer must therefore first be separated (cut) to test the laser. A vertical emitter may thus be tested while it is still situated on the wafer, i.e., prior to separation. This is because it radiates upwardly.

Furthermore, it is advantageously particularly easy to generate or produce short pulses of <1 ns pulse rise time using such vertical emitters. This applies in particular to a higher duty cycle compared to conventional edge emitters. The duty cycle is understood to mean the ratio between “in operation, i.e., active” and “not in operation, i.e., not active.” In one specific embodiment, a duty cycle of the solid-state laser is between 1% and 2%. Edge emitters today partially achieve only less than 1% or less.

A solid-state laser within the context of the present invention in particular includes a laser-active material, which is incorporated in a crystal lattice or another host material.

Examples of such solid-state lasers are: neodymium- or ytterbium-doped yttrium aluminum garnet (Nd:YAG, YB:YAG). Furthermore, according to other specific embodiments, the solid-state laser may also be a semiconductor laser. For example, the semiconductor laser may be an aluminum gallium arsenide laser.

This emits laser radiation having a wavelength of up to 1100 nm. For example, a semiconductor laser may include an indium- or a phosphate-doped laser-active material. Such a semiconductor laser emits laser radiation in the wavelength range of >1000 nm.

In another specific embodiment, it is provided that a processing device is provided, which is designed to ascertain at least one certain area in the illuminatable area based on the recorded image, the pulse laser being operable depending on the ascertained area and/or the mirror being movable depending on the ascertained area in order to be able to appropriately illuminate the certain area. This certain area is also referred to as a “region of interest (ROI).” The search for objects to be detected preferably takes place in this certain area. This means that the maximum possible area is no longer illuminated, but deliberately only the certain area. This advantageously saves measuring time and signal processing time. This means that here, so to speak, the camera (image sensor) is the master, and the LIDAR (pulse laser) is the slave.

According to one specific embodiment, it is provided that only a certain area in the image recorded with the aid of the CMOS compatible image sensor is analyzed and evaluated for object identification and object classification. This certain area is ascertained based on an evaluation of the illuminated area. This means that it is ascertained with the aid of the LIDAR (master) where (i.e., which area or which areas) objects are possibly present in the illuminatable area. Only this area is, or only these areas are, then analyzed in the recorded image. The remainder of the image remains without analysis, i.e., is not analyzed. In this way, computing time and resources may advantageously be saved.

According to another specific embodiment, it is provided that an evaluation device is formed, which is designed to determine a distance from a detected object based on the detected laser pulses. This takes place in particular with the aid of a time of flight measurement of the laser pulses.

According to one specific embodiment, the vehicle LIDAR system is used to detect objects in the surroundings of the vehicle. In particular, a time of flight measurement of the laser pulses is carried out. This means that the pulse laser emits laser pulses. If these laser pulses impinge on objects, they are reflected by these. This takes place at least partially in the direction of the receiver, which may also be referred to as a detector. Based on time of flight measurements of the laser pulses, it is then possible to determine a distance between the object and the vehicle LIDAR system in a conventional manner.

In one specific embodiment, the CMOS compatible image sensor is monolithically composed or formed of silicon, so that no hybrid is to be used, such as in InGaAs TOF systems. Preferably only silicon is thus provided as the sensor material, in particular surface-modified and/or coated silicon.

The present invention is described in greater detail below based on preferred exemplary embodiments.

### BRIEF DESCRIPTION OF THE DRAWINGS

FIG. 1 shows a vehicle LIDAR system.

FIG. 2 shows a further vehicle LIDAR system.

Hereafter, identical reference numerals may be used for identical features.

### DETAILED DESCRIPTION OF EXAMPLE EMBODIMENTS

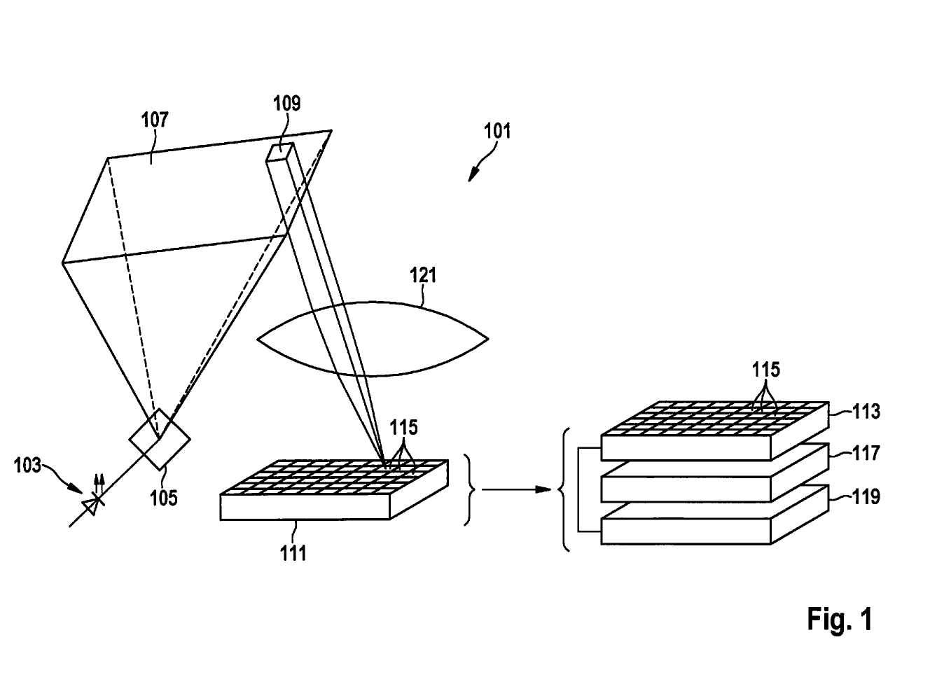

FIG. 1 shows a vehicle LIDAR system 101.

Vehicle LIDAR system 101 includes a pulse laser 103 for emitting laser pulses. A graphical symbol is used to represent pulse laser 103. Pulse laser 103, for example, is a solid-state laser having a brightness of at least 100 kW/(mm² sr), the solid-state laser being designed to emit laser pulses having a wavelength of at least 900 nm, preferably of at least 1000 nm, and a maximum power per laser pulse of at least 50 W. In one further specific embodiment, the solid-state laser is designed as a vertical cavity surface-emitting laser. For example, pulse laser 103 emits laser pulses having a wavelength between 1000 nm and 1100 nm. In particular, a wavelength of the laser pulses is 1060 nm±4 nm. A maximum power per laser pulse is in particular 100 W. A pulse duration of a laser pulse is 2.2 ns, for example.

Vehicle LIDAR system 101 furthermore includes a movably situated mirror 105 for deflecting the laser pulses in the direction of objects to be detected. Mirror 105 is designed as a micromechanical mirror, for example. Due to the movability of mirror 105, an illuminatable area 107 may be formed with the aid of the deflected laser pulses. Such an illuminatable area 107 is often also referred to as a “field of view.” When objects are present within illuminatable area 107, these may be detected with the aid of the vehicle LIDAR system. An object having reference numeral 109 is shown here as an example. This is situated in illuminatable area 107.

The deflected laser pulses impinge on object 109 and are reflected by his the direction of a receiver or detector 111. This receiver or detector 111 is designed to detect laser pulses which were reflected by objects situated in illuminatable area 107. Receiver or detector 111 includes a CMOS compatible image sensor 113. This CMOS compatible image sensor 113 is designed to detect the reflected laser pulses and record an image of illuminatable area 107. Black silicon 113 is provided as the sensor material of CMOS compatible image sensor ill. Black silicon is a surface-structured crystalline silicon. Instead or in addition, it is also possible to use doped crystalline silicon as sensor material. In particular, so-called pink silicon may be used as sensor material.

CMOS compatible image sensor 113 includes multiple pixels 115. Object 109 is thus mapped pixel by pixel. The detected laser pulses are thus detected pixel by pixel.

Detector 111 furthermore includes an evaluation electronics 117, which is designed to read out signals of pixels 115 of CMOS compatible image sensor 113 and ascertains a distance from a detected object, from object 109 here, based on the read-out signals. The ascertainment is based in particular on a time of flight measurement of the laser pulses.

Furthermore, an ASIC 119 is provided. The abbreviation ASIC denotes application-specific integrated circuit. This application-specific integrated circuit 119 is used to carry out the time of flight measurement of CMOS compatible image sensor 113 in a pixel-selective manner.

A lens 121 is provided as the optical element, which maps illuminatable area 107 onto pixels 115 of CMOS compatible image sensor 113. Lens 121 is provided with an anti-reflection coating at a wavelength which corresponds to the laser wavelength±20 nm, in particular ±10 nm. This means that wavelengths within this range are allowed to pass through. Wavelengths outside this range are blocked. Correspondingly, lens 121 includes a highly reflective coating for this wavelength.

CMOS compatible image sensor 113 may furthermore record an image of illuminatable area 107. In this way, it is advantageously possible to both record an image of object 109 and ascertain a distance from object 109. This takes place with the aid of a single sensor, CMOS compatible image sensor 113 here.

According to one further specific embodiment, vehicle LIDAR system 101 is configured as follows:

System 101 includes a light source for emitting laser pulses, for example VCSEL 103 having a laser wavelength between 900 nm and 1300 nm, preferably at 1060 nm±4 nm. VCSEL 103 emits laser pulses which preferably have a peak power of 100 W at a pulse length between 2 ns and 20 ns, preferably 2 ns to 4 ns. The laser radiation of VCSEL 103 having a brightness of more than 100 kW/(mm² sr) is propagated at a pulse repetition rate of preferably 100 kHz onto an optical MEMS mirror 105. This MEMS (microelectromechanical system) mirror 105 has a diameter between 1 mm and 8 mm, preferably between 3 mm and 5 mm, and is provided with a highly reflective layer for the laser wavelength. By moving MEMS mirror 105, the field of view (FOV) (illuminatable area 107) is spanned at preferably 40°×80°. If the laser radiation (i.e., the laser pulses) is reflected by an object, object 109 here, this reflected laser radiation is mapped by lens 121 onto detector 111 including CMOS compatible image sensor 113 having a sensor material made of black silicon. Lens 121 is preferably provided with an anti-reflection coating at the laser wavelength of ±10 nm to ±20 nm. Lens 121 is provided with a highly reflective coating for the remaining wavelength range. Detector 111 made of black silicon additionally has the option of carrying out a time of flight (TOF) measurement for each pixel 115 and groups of pixels 115 to measure the distance from object 109. In addition to the TOF measurement, detector 111 is also able to record an image (camera function) of entire FOV 107, which may be used to calculate an angle resolution, for example, and carry out an object identification. Detector 111 is preferably monolithically made up of silicon, so that no hybrid is to be used (such as in the case of InGaAs TOF systems).

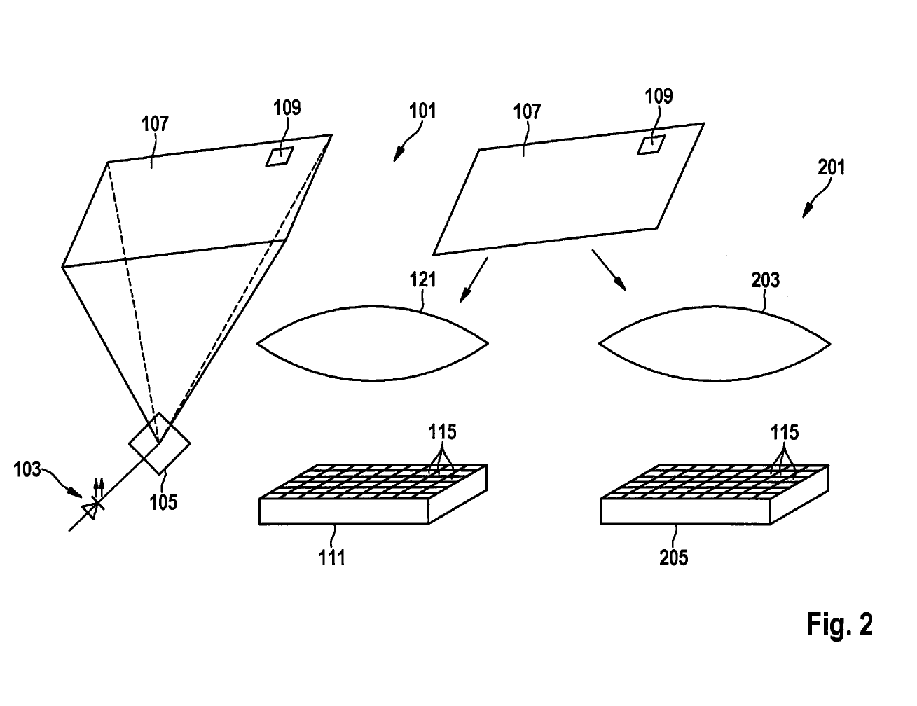

FIG. 2 shows a further vehicle LIDAR system 201.

Vehicle LIDAR system 201 is essentially configured analogously to vehicle LIDAR system 101 according to FIG. 1. Reference is thus made to the corresponding statements. One difference is that the lens which maps illuminatable area 107 onto pixels 115 is not coated like lens 121, but has a broadband anti-reflective design. This lens 121 is denoted by reference numeral 203. For comparison, FIG. 2 additionally also shows vehicle LIDAR system 101 including coated lens 121. In one instance, FOV 107 is thus mapped onto CMOS compatible image sensor 113 with the aid of lens 121, and in the other instance, FOV 107 is mapped onto CMOS compatible image sensor 113 with the aid of lens 201.

As a further difference, a receiver or detector 205 for detecting the laser pulses reflected by the objects is provided, receiver or detector 205 not including evaluation electronics 117 as a difference compared to receiver or detector 111 of vehicle LIDAR system 101. This means that it is not possible to carry out a distance measurement with respect to object 109 to be detected with the aid of receiver 205. Otherwise, receiver 205 includes ASIC 119 and CMOS compatible image sensor 113, similarly to receiver or detector 111, this not being shown in detail in FIG. 2 for the sake of clarity.

Due to lens 203 having an anti-reflective coating for the visible wavelength range (i.e., 380 nm to 780 nm), not only are the wavelengths around the laser wavelength allowed to pass through, but rather also wavelengths in the range of visible light (i.e., 380 nm to 780 nm). In this way, for example, it is advantageously also possible to identify the different colors of a traffic light system. In particular, in this way an image identification may advantageously be carried out more easily and reliably. This is because now pieces of color information are also available to identify objects in the recorded images, for example, based on these pieces of color information. This is in particular advantageous when, for example, traffic signs are to be identified in recorded images.

However, since detector or receiver 205 is also sensitive up to 1100 nm due to the selected sensor material, an active illumination by pulse laser 103 is advantageously effectuated. In this way, it is also possible to record images at night.

In addition to the above-described VCSEL, in further specific embodiments alternative laser sources are also used: for example, at a different wavelength smaller than 1 μm or greater than 1 μm to 1.5 μm. In addition to the semiconductor lasers, inexpensive passive Q-switched solid-state lasers (for example Er/Yb:YAG or glass including a Co:Spinel Q-switch). Due to the selection of a solid-state laser, the MEMS mirror diameter may be reduced to preferably 1 mm compared to semiconductor lasers in view of the better brightness.

Functionally, master-slave configurations are possible: for example, LIDAR function=master. The LIDAR is used to ascertain where objects are in the FOV to define regions of interest for the camera function, i.e., for the CMOS compatible image sensor. This saves computing time, without neglecting areas in the FOV. For example, camera function=master. When objects are identified in the recorded image, the pulse laser is operated in such a way and/or the mirror is moved in such a way that the regions of interests (ROI) are supplemented by an angle and distance identification of the LIDAR.

1-10. (canceled)

11. A vehicle LIDAR system, comprising:
a pulse laser to emit laser pulses;
at least one movably situated mirror to deflect the laser pulses in a direction of an object to be detected; and
a receiver to detect the laser pulses reflected by the object, wherein the receiver includes a CMOS compatible image sensor to detect the reflected laser pulses and to record an image of an area illuminatable with the aid of the deflected laser pulses.

12. The vehicle LIDAR system as recited in claim 11, wherein the CMOS compatible image sensor includes multiple pixels, and wherein the vehicle LIDAR system further comprises:
evaluation electronics designed to read out signals of the pixels of the CMOS compatible image sensor and ascertain a distance from a detected object based on the read-out signals.

13. The vehicle LIDAR system as recited in claim 11, further comprising:
an optical element to map the illuminatable area onto the CMOS compatible image sensor.

14. The vehicle LIDAR system as recited in claim 13, wherein the optical element has a transmission of at least 80% for a wavelength range which corresponds to the laser wavelength plus minus 100 nm, the transmission for wavelengths outside the wavelength range being less than 50%.

15. The vehicle LIDAR system as recited in claim 11, wherein the CMOS compatible image sensor is designed to detect electromagnetic radiation having a wavelength of at least 900 nm.

16. The vehicle LIDAR system as recited in claim 11, wherein the CMOS compatible image sensor includes at least one of a doped and a surface-modified silicon, as sensor material.

17. The vehicle LIDAR system as recited in claim 11, wherein the pulse laser is a solid-state laser having a brightness of at least 100 kW/(mm² sr), which is designed to emit laser pulses having a wavelength of at least 900 nm and a maximum power per laser pulse of at least 50 W.

18. The vehicle LIDAR system as recited in claim 17, wherein the solid-state laser is designed as a vertical cavity surface-emitting laser (VCSEL).

19. The vehicle LIDAR system as recited in claim 11, further comprising:
a processing device designed to ascertain at least one certain area in the illuminatable area based on the recorded image, wherein at least one of: i) the pulse laser being operable depending on the ascertained area, and ii) the mirror being movable depending on the ascertained area, in order to be able to appropriately illuminate the certain area.

20. A vehicle LIDAR system for detecting an object in the surroundings of a vehicle, the vehicle LIDAR system comprising:
a pulse laser to emit laser pulses;
at least one movably situated mirror to deflect the laser pulses in a direction of an object in the surroundings of the vehicle to be detected; and
a receiver to detect the laser pulses reflected by the object, wherein the receiver includes a CMOS compatible image sensor to detect the reflected laser pulses and to record an image of an area illuminatable with the aid of the deflected laser pulses.
